(19) United States
(12) Patent Application Publication
(10) Pub. No.: US 2002/0156909 A1
(43) Pub. Date: Oct. 24, 2002

(54) System and method for server side control of a flash presentation

(76) Inventor: Jeffrey M. Harrington, Brooklyn, NY (US)

Correspondence Address: DORSEY & WHITNEY, LLP, SUITE 4700, 370 SEVENTEENTH STREET, DENVER, CO, 80202-5647, US

(21) Appl. No.: 10/077,284

(22) Filed: Feb. 14, 2002

Related U.S. Application Data
(60) Provisional application No. 60/269,593, filed on Feb. 15, 2001.

(51) Int. Cl. G06F 15/16

(52) U.S. Cl. 709/231; 709/217

(57) ABSTRACT

A system and method for controlling a Flash presentation on a client device through the use of a command received from a server is disclosed. The Flash presentation may be further synchronized to a programming signal by receiving a Universal Resource Indicator (“URI”) specifying the location of a Flash movie that relates to the programming signal; retrieving the Flash movie from the location; loading the Flash movie onto the client device including a Flash player; establishing a connection between the client device and a server; and receiving a command from the server to direct the Flash movie on the client device. A Flash presentation may also be used to present a real-time data feed on a client device under the control of a server. The server receives a real-time data feed and generates a command directed to a Flash movie on the client device. The command directs the presentation of the Flash movie.

### REFERENCE TO RELATED APPLICATIONS

This application claims the benefit of U.S. Provisional Application No. 60/269,593 entitled “SYSTEM AND METHOD FOR SERVER-SIDE CONTROL OF A FLASH PRESENTATION” and filed on Feb. 15, 2001 by Jeffrey M. Harrington, which is incorporated herein by reference in its entirety. This application is further related to the following applications, which are incorporated herein by reference in their entirety: U.S. patent application Ser. No. 09/396,693 of Craig D. Ullman, Michael R. Abato, Jeffrey M. Harrington, and Carl R. Duda, entitled “ENHANCED VIDEO PROGRAMMING SYSTEM AND METHOD FOR PROVIDING A DISTRIBUTED COMMUNITY NETWORK,” and filed on Sep. 15, 1999 (hereafter, the “DCN application”); U.S. patent application Ser. No. 09/472,385 of Craig Ullman, Jack D. Hidary, and Nova T. Spivack entitled “ENHANCED VIDEO PROGRAMMING SYSTEM AND METHOD INCORPORATING AND DISPLAYING RETRIEVED INTEGRATED INTERNET INFORMATION SEGMENTS,” and filed Dec. 23, 1999; and U.S. provisional patent application of Michael R. Abato, entitled “A SYSTEM AND METHOD FOR PRESENTING CONTENT RELATED TO A TEMPORAL EVENT TO A USER VIA A VIRTUAL STAGE,” and filed on Feb. 15, 2001 (hereafter, the “STAGE” application”).

### FIELD OF THE INVENTION

The present invention relates generally to a Flash movie playing on a client device. In more particularity, the present invention relates to server-side control of a Flash movie playing on a client device. In addition, the present invention relates to synchronizing programming with a Flash movie playing on a client device.

### BACKGROUND OF THE INVENTION

Today, the capabilities of computers to provide massive amounts of educational and entertainment information have exploded with the Internet. The Internet has the power to transform society through unprecedented levels of information flow between members. Currently, on-line systems offer a variety of different services to users, including news feeds, electronic databases (either searchable by the user directly on the on-line system, or downloadable to the user's own computer), private message services, electronic newsletters, real time games for play by several users at the same time, and job placement services, to name a few. However, today, most on-line communications occur merely through text. This currently stands in great contrast to the audio/visual presentation of the alternative electronic medium, television. However, it is expected that as multi-media's incessant growth continues, audio/visual programs will proliferate and text will become less and less dominant in the on-line environment. Even though these programs will be introduced, the Internet will remain essentially user unfriendly due to its very massiveness, organization, and randomness. Simply stated, there is no order or direction in the Internet. Specific pieces of information are many times hard to find, and harder yet, is the ability to put that piece of information into a meaningful context.

Television, on the other hand, has been criticized for being a passive medium—“chewing gum for the eyes,” as Fred Allen once observed. Television has always been something you watched, not something you do. Many social critics believe that the passivity television depends on has seeped into our entire culture, turning a nation of citizens into a nation of viewers. While interactive television systems have increased the level of user interaction, and, thus, provided greater learning and entertainment opportunities, vast information resources such as databases are inaccessible from such a medium.

Recent innovations in combining Internet content with television and other audio and/or video programming signals have been described in various patents and publications, for example, U.S. Pat. No. 5,778,181, which issued on Jul. 7, 1998 to Jack D. Hidary, et al., and also in U.S. Pat. No. 5,774,664, which issued on Jun. 30, 1998 to Jack D. Hidary, et al. (hereinafter, collectively the “Hidary patents”), and also U.S. Pat. No. 6,018,768, which issued on Jan. 25, 2000 to Craig Ulman et al. The contents of each of these patents are herein incorporated by reference in their entirety. As is now well known in the art, these patents describe innovative systems and processes for combining the user-friendly visual experience of television programming signals, and other time based events or signals, with information resources located on the Internet which relate to the programming signal (hereinafter, the “Enhanced Content”). Since segments in a programming signal are generally presented in a sequence to a client based upon a reference to a known event (for example, the amount of time remaining in a football game is based upon the kick-off, or the amount of time remaining in a recorded movie is based upon when the playback of the movie is started and not when it was actually filmed), such programming signals shall herein be regarded as applying to any signal, show, or sequence of events, whether pre-recorded or live, which are defined or based upon a temporal relationship (hereinafter, the “Temporal Signal”). Such Temporal Signals may include live events (for example, a cut-away by a television broadcaster to a then breaking news event), pre-recorded events, and combinations of live and pre-recorded events.

Recently, various approaches have been implemented for providing client-side and server-side systems capable of providing Enhanced Content related to a Temporal Signal. As is well known in the art, such approaches generally require a client to download (commonly from an Internet based Web site) and then install a proprietary plug-in or software, which configures the client's system as a specific application. Another approach utilizes a client system's Web browser, and a downloaded program which configures the client system to retrieve Enhanced Content over a specific type of communications link, for a specific type of client device based upon the reception of a Temporal Signal and an address identifying a provider of Enhanced Content related thereto. Regardless of the specific methodology, today's client systems commonly must download and install an application program to receive and present Enhanced Content program segments, which relate to a given Temporal Signal.

Further, since the Internet has innumerable sites, which a client may or may not find using a search engine, producers of Temporal Signals often identify a location providing Enhanced Content (for example, an Internet site) by presenting a Uniform Resource Identifier (URI), which includes Uniform Resource Locators (“URL”), or similar address in the video or audio signal presenting the Temporal Signal. Once the site is identified by the client and/or the client's system, the approach then commonly requires the client system to register the client with the provider of the Enhanced Content.

Following registration, the client then may actually need to select a program or segment for which the client desires to receive the Enhanced Content (since Enhanced Content for multiple programs may be accessible from a single Internet site). Once selected, the client side system then often downloads and installs a browser plug-in, Java applet, Java script application, Shockwave™ component, or similar program code, which configures the client device for connecting with a persistent socket to a server to receive the specific Enhanced Content. A persistent socket, for example, may be implemented via, but is not limited to, a TCP/IP socket, any sort of communication protocol that implements persistence, or an application layer that implements persistence. At this point, the client system is then ready to connect to the provider of the Enhanced Content, satisfy any pre-requisites (for example, providing a password, sign-on, or user profile information), and receive the Enhanced Content.

As such, the approaches commonly utilized today to receive Enhanced Content generally require a client to first identify the location of a provider of Enhanced Content, register the client with the provider, download a program which configures the client system, install the program, connect to a site providing Enhanced Content related to a specific Temporal Signal, and then satisfy any prerequisites prior to receiving the Enhanced Content (for example, providing user profile information). In short, these approaches require so much time and effort to configure the client side system and access the Enhanced Content that many clients are discouraged from utilizing such systems.

What is needed is a means to reduce and minimize the amount of time and effort required by a client to receive automatically, or upon request, Enhanced Content related to a Temporal Signal. What is needed is a wider, richer, quicker, and more efficient system and process for receiving and processing audio/visual and textual database elements into an organized unique interactive, educational, entertainment experience.

Macromedia Flash™ technology includes a powerful animation application, which may substantially replace the hypertext mark-up language (“HTML”) as the application of choice for Web site developers. A programmer using Flash can create interactive Web sites with sophisticated animation and sound, requiring low bandwidth and small file sizes. The visual presentation of a Web site using Flash is referred to as a Flash movie, which provides a window for capturing and displaying information, similar to an HTML page. Flash movies, unlike HTML pages, stay loaded in a Web browser, or any device with a Flash plug-in. In a most basic implementation, the Flash movie includes a series of vector graphic images that are animated by changing their parameters in keyframes along a timeline, conceptually similar to the way in which animation in a cartoon is achieved.

For a more sophisticated site, Flash also includes functionality to create interactive movies, where the visitor to the Web site may use a keyboard or a mouse to jump to different parts of the movie, enter information on forms, and perform other interactive operations. Flash movies may run from start to finish, or a viewer of the Flash movie may direct the Flash movie to change state. Flash also provides for layering, which allows movies and functionality to be overlaid. For example, a Flash movie illustrating human anatomy might have a first layer with graphics of a skeleton and a second layer with graphics of the muscular system overlaid on the graphic of the skeleton. The movie might include a third layer with text describing the various anatomical features. As one can imagine, layering can be used to enhance the functionality and visual appeal of a Web site.

What is needed is a system and method for synchronizing the visual experience of TV with the dynamic capabilities of Flash movies on a client device. What is further needed is a system and method for server-side control of a Flash movie playing on a client device.

### SUMMARY OF THE INVENTION

Systems consistent with the present invention provide a system and method for relating Temporal Signals (which appear, for example, on a television broadcast, a VHS or Beta tape, CD-ROM, DVD, CD, memory stick, or other medium) with a Flash movie on a client device (accessible, for example, via the Internet). Such systems do not require lengthy downloads, specific client devices or operating systems, specific data formats or similar constraints in order to implement the features and functions identified herein. Preferably, such a system is implemented on a client device capable of hosting a Web browser. As such, the present invention is described preferably in the context of a client device using a Web browser for supporting its operations.

Further, the present invention creates a new, efficient, dynamic, diverse and powerful educational and entertainment medium. The system allows consumers to receive more information in a more efficient manner than either television or the Internet alone and over prior systems and processes utilized to present Enhanced Content related to a Temporal Signal. Instead of requiring client systems to execute lengthy, and sometimes problematic, downloads, which often require the user to perform an installation of new software on the client system prior to receiving an Enhanced Content segment, the present invention streamlines such processes by providing server-side control of a Flash movie playing on a client device. By utilizing server-side control, the present invention minimizes the amount of client-side software that needs to be downloaded. As such, the Enhanced Content segments are available for immediate use without requiring a lengthy download or installation phase. In such an embodiment, the Flash movie is preferably played using any standard Web browser that has a Flash plug-in, which is estimated to be currently installed on over 96% of all Web compatible computers. As such, by using the new systems and processes of the present invention, consumers not only can see a news report on television, but they can also be pushed pertinent information which will be displayed on the client device. The act of viewing a program has now become a more engaging, enriching experience, because Enhanced Content can now be obtained almost instantaneously without any lengthy downloads and installations, initialization routines, or constraints upon compatible systems or sources.

The present invention can also create a more intimate relationship between the client and the program. For example, in an educational environment, a student (the client) might be solving problems or performing virtual experiments on an Internet site that a teacher is discussing in an educational television program. The client is an active participant in the process, rather than a passive observer. Unlike previous systems, the present invention enables the student and the teacher to visit the classroom via any device capable of playing a Flash movie and connecting to a server, including the ever more increasingly popular wireless devices such as Personal Data Assistants (“PDA”) and wireless communications devices. Such capabilities are possible with the present invention because the invention provides for pushing commands from the server to the client device (regardless of the device's specific configuration and/or capabilities above a minimum threshold as defined in terms of providing a Web browser or a comparable presentation mechanism and some accessible memory) to control the Flash movie relating to the temporal event. The server can contain sophisticated program logic, which would otherwise need to be downloaded and installed on the client device, to allow for more complex presentation options. In an educational setting where a student answers a question wrong, for example, the server may re-push material that was not understood or may even push a more detailed explanation for easier understanding by the student. Thus, this allows for more sophisticated user experiences without the necessity of performing lengthy, and sometimes problematic, downloads and installations of the application software.

Another advantage of the system is that it changes the nature of advertising by making its application delivery more adaptable to the viewers. By keeping the complex programming logic on the server-side of the system, advertising can be more easily created and delivered in a targeted and individualized manner while allowing the client side content delivery to be instantly available. Branching logics and interactive sales presentations can be delivered without lengthy downloads. Since additional information can be now given to consumers automatically and without large downloads, advertising can now be more interactive, responsive, and substantive. Such real-time responsiveness allows customers to make more informed choices and spontaneous choices. Now, the act of purchasing a product seen on television can be streamlined—the consumer can be given the choice of buying the product instantly using the two-way capabilities of the system. For example, the processes of the present invention enable an Enhanced Content provider to push a command to the Flash movie playing on the client device, and the command can seamlessly display a button for purchasing the product at a newly displayed price. The button includes the functionality necessary to purchase the product from a remote location.

In addition, users can take advantage of the two-way capabilities of the Internet to respond to polls, to send e-mail, or to link to additional sites. For example, a viewer watching a television financial news program, through the system of the present invention, can receive a real-time data feed that will be displayed, perhaps as a layer on the Flash movie.

The present invention includes a method for synchronizing programming with a Flash movie on a client device, which includes receiving programming on the client device. The programming contains a Uniform Resource Indicator (“URI”), such as a Uniform Resource Locator (“URL”), functional push, an object push, and a software enhancement push (i.e., the software on the client side can be dynamically enhanced without user intervention). The programming may be video programming, audio programming, or other Temporal Signals, as defined herein. According to one aspect of the present invention, the URI specifies a location from where a Flash movie can be obtained, wherein the Flash movie relates to the content of the programming. The Flash movie is then retrieved from the location and loaded on the client device.

In one aspect of the present invention, the client device includes a Flash player, a Web browser having Flash movie playing capabilities, such as a Flash plug-in, or another application having Flash movie playing capabilities, such as an e-mail client. A connection is established between the client device and a server, such as a Web server, a DCN server, or a database server. To facilitate the connection, the client device preferably includes a receiver software layer, such as an ActiveX control, and a bridge layer, preferably running in a browser window with scripting capabilities such as JavaScript or VBScript. The receiver software layer, for example, may be located within a frame containing an active component capable of establishing a persistent socket or may utilize Flash 5 XMLSocket capabilities. The bridge layer can be used to communicate between the active socket component, i.e., the receiver layer, and the Flash movie, such as via a “LiveConnect” interface. The client device receives a command from the server via the receiver layer and passes it through the bridge layer to the Flash movie. Any client-side processing or logical operations are performed, and the push command, the data, or the software command is sent to the client device directing the presentation of the Flash movie.

### BRIEF DESCRIPTION OF THE DRAWINGS

FIG. 1 is a diagram of a first system according to the present invention for synchronizing a Flash movie on a client device with a programming signal, and for server-side control of the Flash movie;

FIG. 2 is a block diagram illustrating an exemplary client device according to the present invention;

FIG. 3 is a flow diagram illustrating a method according to the present invention for synchronizing a Flash movie on a client device with a programming signal, and for server-side control of the Flash movie;

FIG. 4 is a diagram of a second system according to the present invention for server-side control of a Flash movie, the second system including a producer sending commands to a Flash movie on a client device, the commands relating to a Temporal Signal;

FIG. 5 is a flow diagram illustrating a method according to the present invention for server-side control of a Flash movie;

FIG. 5a is a flow diagram illustrating a method according to the present invention for loading a Flash movie on a client device;

FIG. 5b is a flow diagram illustrating a method according to the present invention for transmitting a command from a producer to a server;

FIG. 6 is a diagram of a third system according to the present invention for server-side control of a Flash movie relating to a programming signal;

FIG. 7 is a diagram of a fourth system according to the present invention including a first client device with a communication link to a second client device;

FIG. 8 is a diagram of a fifth system according to the present invention for broadcasting a real-time data command correlating to a real-time data feed to at least one client device having a Flash movie;

FIG. 9 is a diagram of a sixth exemplary system according to the present invention for server-side control of a Flash movie playing on a client device, wherein the client pushes commands to the server, which are then broadcast to a plurality of client devices; and

FIG. 10 is a diagram of a seventh exemplary system according to the present invention for server-side control of a Flash movie playing on a client device, wherein the client pushes commands to the server, which are then sent to one other client device.

### DETAILED DESCRIPTION OF THE PREFERRED EMBODIMENTS

A first exemplary system consistent with the present invention preferably combines the rich visual capabilities of video with the dynamic capabilities of Macromedia Flash™ technology to provide a synchronized experience, and to provide a means for server-side control of the Flash movie. The first system preferably refers to video programming; however, the systems and methods described herein are equally applicable to any programming signal including, for example, audio, streaming video, streaming audio, holographic images, virtual reality signals, and any other type of Temporal Signals.

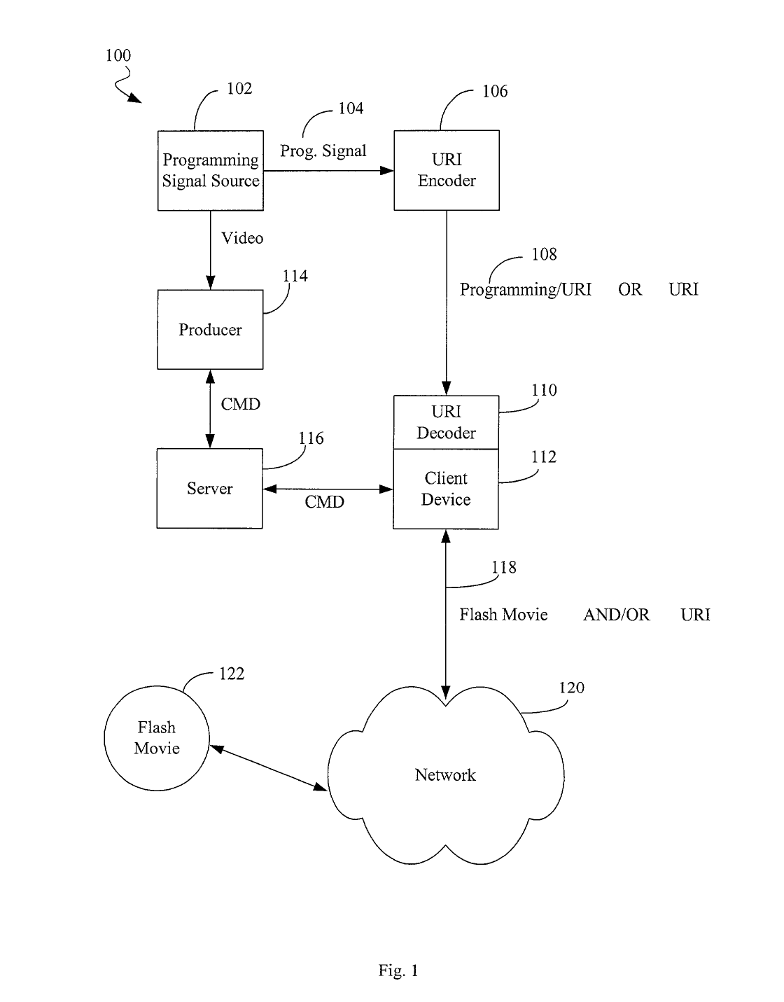

Referring to FIG. 1, an embodiment of the first system 100 of the present invention for synchronizing a Flash movie 122 on a client device with a programming signal 104 via server-side control of the Flash movie 122 is illustrated. This embodiment allows a client device 112 to receive a programming signal 104, such as a video programming signal, with an embedded Uniform Resource Identifier URI, collectively the combined signal 108. An URI, for example, may identify to the client device 112 an address location on a network 120 where a Flash movie 122 is located. The client device 112, whether automatically (for example, a push) or upon client direction (for example, a pull), retrieves Flash movies 122 from the address location. The client device 112 may be a personal computer, a set-top box, a digital TV, a Web tablet, a PDA, a wireless device, or any other device with a connection to a network and the ability to run a Web browser with a Flash player. A Flash player on a personal computer or other client device, for example, may be used as a screen saver for taking over a display screen if there are no user inputs such as keystrokes or mouse movements for a specified duration. Thus, the Flash movie may provide animations, graphics, text, and the like on the display. Alternatively, the client device 112 may be any device capable of running a stand-alone Flash player and communicating with a network 120.

In the embodiment illustrated in FIG. 1, the client device 112 is also preferably connected to either a cable and/or broadcast television connection or to a local VCR or other video source, and receives a programming signal by that connection. The programming signal 104 can then be processed for presentation, such as for display on a screen of the client device 112 using any conventional PC card capable of displaying NTSC signals on a screen, such as a WinTV card, and/or played over a speaker of the client device 112 using any conventional PC audio card. Alternatively, the client device 112 may be run in parallel with a second client device for viewing video programming, such as a television or for listening to audio programming, such as a radio.

The programming signal is preferably distributed to viewers in their homes from a centralized location, e.g., the programming signal source 102, and is created according to any conventional means known in the art. After the programming signal is created, an URI or a plurality of URI(s) are embedded into the programming signal 104 via the URI encoder 106. In one embodiment, for example, the URI can be embedded into the Vertical Blank Interval (“VBI”) of the video programming by the URI encoder 106. In this embodiment, the URI is preferably encoded into eight fields of line 21 of the VBI. Line 21 is the line associated with close captioning, among other things. However, the URI could also be embedded in other fields of the VBI, in the horizontal portion of the video, as part of the audio channel, in any subcarrier to the video, or if digital, in one or more of the data fields. In a video programming embodiment, the particular information in line 21 is not part of the visual part of the program, is not perceptible to the human eye, and, thus, is ideal to send data information to the users. While the bandwidth capacity of line 21 is limited, because the system transmits only the URI(s), and not full Flash movies, there is more than enough capacity. Furthermore, no additional hardware is necessary at the client device to implement the elements of the present invention. Thus, the present invention has the additional advantages of being very efficient and takes advantage of conventional hardware.

Although FIG. 1 shows the programming signal with an embedded URI transmitted over the same line, the URI(s) alternatively can be transmitted independently of the programming signal on the same data channel or over a different data channel, or via the network itself. In this embodiment, the URI(s) can be forwarded to the remote sites either prior to initiation or during the transmission of the programming signal 104. In one embodiment, the URI(s) have associated time stamps, which indicate to the subscriber platforms (e.g., the client device 112) when, during the programming signal 104, to fetch and play Flash movie(s), which can be obtained via the network 120 or other device identified by an address specified by the particular URI(s). As shown in FIG. 1, a Flash movie 122 is illustrated as being associated with the address provided in the URI. The Flash movie 122 may reside on a server or any other device that may be identified by an address or similar designator and from which the Flash movie may be obtained. For example, when the Flash movie 122 associated with a given URI is provided on a CD or DVD, the URI may refer to a location on such computer readable medium at which the data of interest (i.e., the Flash movie) is stored. In such an embodiment, the DVD player effectively operates as a server by providing the Flash movie 122 to the client device 112. In the preferred embodiment for this system 100, however the URI suitably identifies a server accessible via the network 120, for example, the Internet. Alternatively, as discussed in more detail below, the user can select when to call the particular Flash movie(s) for display with the programming signal 104.

Once the programming signal 104 is created, it can be transmitted to user sites over any transmission means, including broadcast, cable, satellite, or Internet, and may reside on servers, such as video or audio servers. Furthermore, the programming signal 104, one or more URI(s), and/or the combined signal 108 can be encoded on a storage medium, such as a VHS tape, a Beta tape, an audio tape, a digital audio tape (“DAT”), DVD, CD, CD-ROM, CD-R, CD-RW, or other storage medium. Also, digital recording mechanisms and devices, such as a TiVO® unit, may be utilized to record and/or play back any recordings of the programming signal 104, the URI(s), and/or the combined signal 108.

The programming signals 104 and/or the combined signal 108 may also be communicated as a live or prerecorded signal to the client device 112. Such communications may be pre-set (for example, based upon a network broadcast schedule), may be real-time (for example, when a breaking news event occurs), and/or may be on-demand. For example, the programming signal 104, the URI(s), and/or the combined signal 108 may reside on audio and/or video servers until requested by a client (for example, as video on demand).

In the embodiment illustrated in FIG. 1, for example, a local URI decoder 110 receives the combined signal 108 including the programming signal 104 with the encoded URI(s). The local URI decoder 110 extracts the URI(s), preferably embedded in the VBI, with the use of any conventional decoder device. The URI decoder 110 may include a stand-alone unit, include hardware associated with the client device 112, such as a card that is connected to the client device, and/or a software application running on the client device 112. Alternatively, the URI decoder may be located at a server connected with the network. When the URI decoder receives the combined signal 108, it strips out the URI(s), such as from line 21 of the VBI, and delivers the URI(S) independently to a server. The URI is then subsequently delivered via the network 120 to the client device 112. Simultaneously, the programming signal 104 is broadcast over conventional broadcast or cable transmission means to the client device 112.

When the client device 112 receives the URI, the Flash movie 122 residing at the URI is loaded into the memory of the client device 112. Preferably, the client device 112 automatically establishes a communications link with a server located at the URI, accesses the URI, and loads the Flash movie 122 (i.e., a configuration often referred to as a “push”). Alternatively, the client device 112 may be configured to establish the communications link with the server upon the receipt of an URI and a command from a client directing the client device 112 to retrieve the Flash movie 122 (i.e., a configuration often referred to as a “pull”). As such, the client device 112 may be configured to be “pushed” or to “pull” Flash movies identified by an URI provided in conjunction with a programming signal 104.

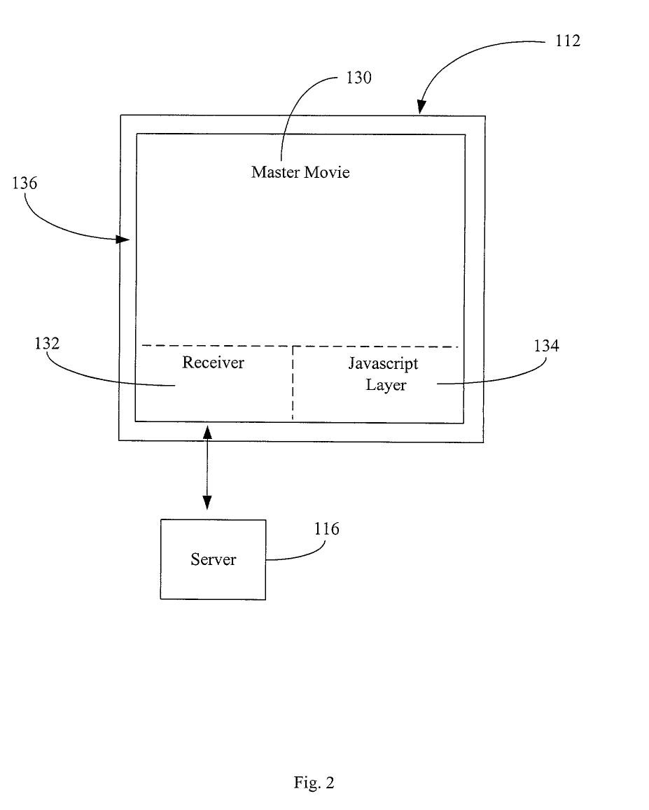

The URI decoder 110 of FIG. 1 preferably routes the URI(s) to a device or a portion of the client device 112 configured to receive URI(s), such as a Web browser on a personal computer, a set-top box, a digital TV, a wireless device, a gaming console, a wireless telephone, a PDA, or any other device capable of presenting a Flash movie. Since the URI(s) identify Flash movies 122, which require Flash capabilities, preferably the Web browser 136 (shown in FIG. 2) includes a Flash™ player. However, the client device 112 may also be configured with a stand-alone Flash™ player (i.e., a Flash™ player that operates independent of or in conjunction with a Web browser in order to present a Flash movie). Currently, any Flash™ equipped Web browser (for example, a Microsoft® Internet Explorer® or Netscape® Navigator™ browser) is capable of presenting a Flash movie without modification to the Flash movie or to the Web browser. As shown in FIG. 2, for the first embodiment of the present invention, a Flash™ compatible Web browser 136 is used to present the Flash movie 122.

However, it is anticipated that as Flash Movies become more ubiquitous, devices will be provided for presenting Flash Movies without requiring or utilizing the full capabilities of a Web browser. As such, the client device 112 preferably may be configured to provide a platform for receiving URI(s) and presenting Flash movies 122 in conjunction with or separate from the reception and presentation of a programming signal 104. Such a client device 112 may not require or utilize the full capabilities of a Web browser operating on a personal computer or similar device. Thus, it is to be appreciated that for the system 100 shown in FIG. 1, the client device 112 provides the capabilities of identifying, locating, retrieving and presenting Flash movies in conjunction with a programming signal by utilizing URI(s) or other schemes for identifying local and/or remotely located Flash movies.

For the embodiment shown in FIG. 1, the client device 112 suitably communicates with a server 126 and provides any URI(s) received from the URI decoder 110 to the network 120 over a suitable communications link 118. In FIG. 1, a single bi-directional communications link is commonly adequate for facilitating communications between the client device 112 and the network 120. However, in certain embodiments, wherein high speed communications are utilized, parallel and/or numerous communications links may be utilized. Further, the communications links shown in FIG. 1, and throughout the Figures, are provided for illustrative purposes only and are not to be construed as depicting an actual or preferred hardwire configuration. As is commonly appreciated, Web browsers commonly connect with a server, associated with a particular URI, via the Internet, a Local Area Network (“LAN”), a wired network, a wireless network, a combination wired and wireless network and/or a proprietary system providing a non-standard extension such as a Distributed Community Network (“DCN”). For a description of a DCN, see U.S. patent application Ser. No. 09/396693, which was filed on Sep. 15, 1999 in the name of inventors Craig Ullman et al., and is entitled “Enhanced Video Programming System and Method for Providing a Distributed Community Network”, the contents of which are herein incorporated by reference in their entirety.

In the embodiment illustrated in FIG. 1, a producer 114 is connected with a server 116, which is connected to the client device 112. In this embodiment, the server 116 is shown separate from the network 120. The server 116, however, may also be a server residing on the network 120. Connected with the client device 112, via the server 116, the producer 114 may direct the Flash movie 122 to relate with the programming signal 104, and additionally, or alternatively, direct the Flash movie 122 to relate to other Temporal Signals. For example, the producer, using a command line interface, may issue a command to the Flash movie 122 residing on the client device 112. The command will be sent to the server 116, which in turn will send the command to the client device 112.

An exemplary client device is illustrated in FIG. 2. The client device 112 includes a Flash master movie 130, a receiver 132, and a bridge layer 134, running in a browser window 136 with scripting capabilities such as JavaScript or VBScript. The receiver 132 is connected to a server. Preferably, the receiver 132 is implemented as an ActiveX control or a Java Applet, and facilitates communication between the Flash movie, e.g., the Flash movie 122 shown in FIG. 1, and the server. The server may be a Web server, a DCN server, or any other type of server. The receiver communicates with the bridge layer 134, which in turn communicates with the Flash movie 130. The bridge layer 143 may, for example, run in the browser window with scripting capabilities such as, but not limited to, JavaScript or VBScript (hereinafter, for simplicity, the terms “bridge layer” and “JavaScript layer” are used interchangeably although one skilled in the art would readily appreciate that the bridge layer may be implemented using JavaScript, VB Script, or other known scripting capabilities).

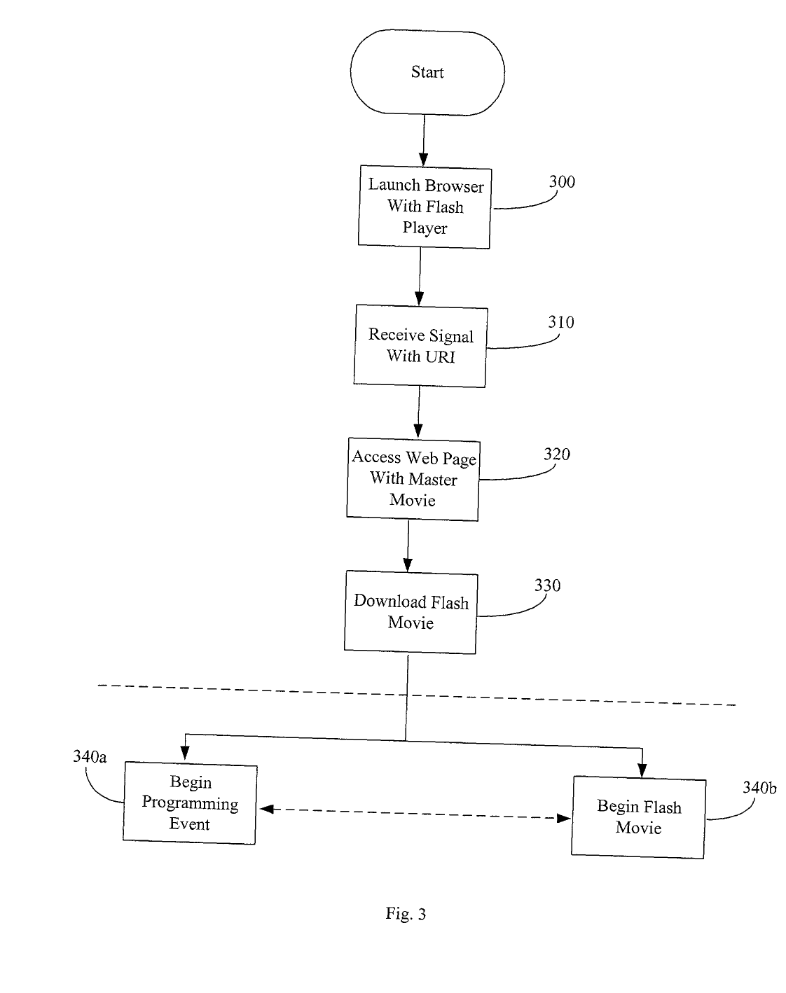

A first method consistent with the present invention relates a Flash presentation with a programming signal. Referring to FIG. 3, a preferred method for relating a Flash presentation with a programming signal, such as a video programming signal, is illustrated. In operation 300, a user of the client device preferably launches a Web browser having a Flash player. The client device, for example, may be a personal computer, a set-top box, a wireless device, or any other device with a connection to a network and the ability to run a Web browser. Alternatively, the Web browser may include a Flash plug-in, which facilitates the execution of a Flash movie on the client device. Alternatively, the client device may be capable of running a stand-alone Flash Player, such as a Sony PS2 Game Console™, and communicating with the network. A preferred embodiment of the client device is illustrated in FIG. 2.

In operation 310, the client device receives a programming signal having an embedded URI, which preferably directs the Web browser to a network location, such as a Web site, with a Flash movie relating to the programming signal. Preferably, as discussed hereinbefore, the URI may be embedded in the first 21 lines of the VBI. Alternatively, the URI may be sent independently of the programming signal, such as via a server. The delivery of the URI for the movie that relates to the programming signal is a means for synchronizing a Temporal Signal, such as a programming signal, with a Flash movie.

In operation 320, the client device is connected with the Web page corresponding to the URI, the Web page having the master movie. In operation 330, the Flash movie is loaded on the client device. In one embodiment, the URI is accessed and the Flash movie is downloaded automatically by the client device when the URI is received. Alternatively, the user may manually enter the URI into the browser, and connect with the Web page, and download the master movie. Preferably, the downloaded Flash movie is a master movie.

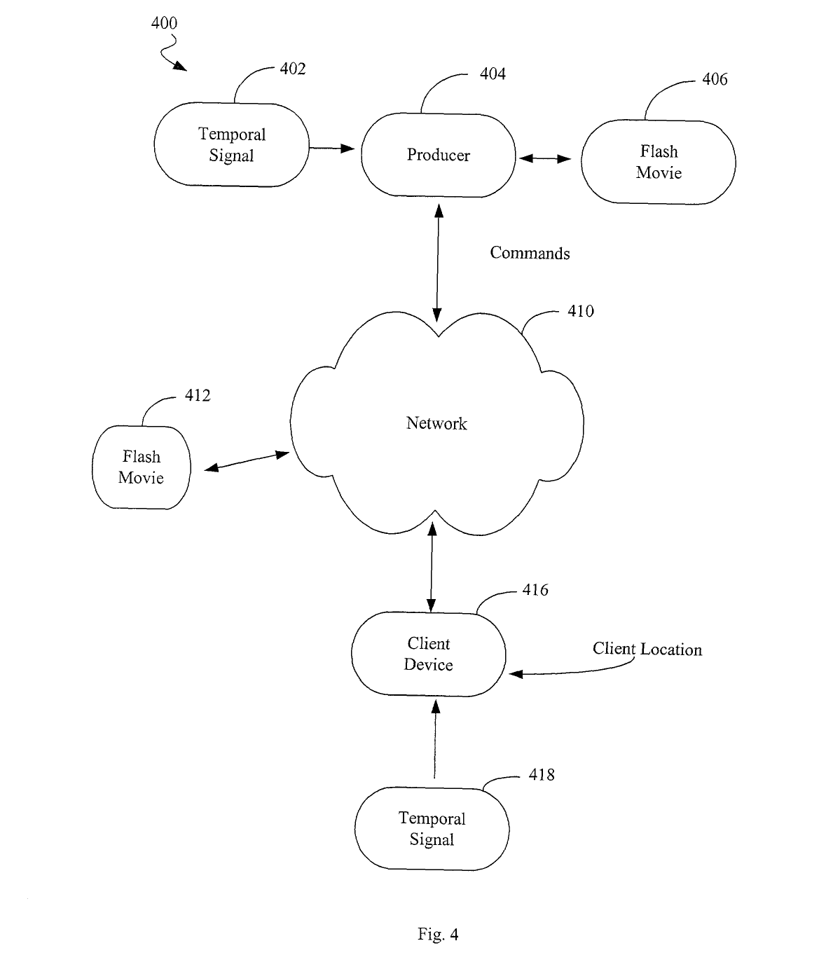

As used herein, the master movie is preferably a Flash movie having the core functionality relating to the programming signal. For example, a master movie designated to relate with a live television broadcast of a football game, may include touchdown graphics, and text corresponding to key players on the teams. Non-core functionality, which may be pushed to the master movie by the producer according to the present invention, might include a sudden death overtime graphic. In an alternative example, such as with the system 400 of FIG. 4, the Flash movie 412 is generally a stand-alone presentation, which may be controlled by a producer 404 or controlled by a server-side playlist, script, application, or other functionality on the server according to the present invention. As is well known in the art, Macromedia ActionScript™ is an object-oriented scripting language that allows a user to define a set of instructions that run when a triggering event occurs. There are various events that trigger a script including the viewer clicking on a button or the movie reaching a certain point along its timeline. For example, a button may be displayed on the Flash movie that is associated with a script that jumps to an URI, such as a URL, and fetches a document, conceptually similar to an HTML hyperlink, and when the viewer clicks on the button the script is executed and the document is fetched. In another example, a movie may be stopped when it reaches a certain point along its timeline such as when a Web site's introductory graphics have concluded.

In operation 340a (FIG. 3), a programming event is started, and in operation 340b, the master movie is started, preferably contemporaneously with the programming event, and the events are synchronized, and or related to one another through server-side control of the Flash movie on the client device according to one embodiment of the present invention.

According to the present invention, the Flash movie running on the client device may be synchronized with the programming signal through server-side control. In addition, according to the present invention the Flash movie on the client device may be directed by the producer, or directed by server-side controls. The client device, such as the client device illustrated in FIG. 2, is connected with the server.

One example consistent with the present invention for server-side control of the Flash movie on the client device includes having a playlist resident on the server, the playlist being for the Flash movie being presented on the client device. The playlist includes a timeline, and at least one command related to the timeline. The playlist may be played from the server, which will issue the command at the appropriate time to the Flash movie playing on the client device. To synchronize the Flash movie on the client device with the programming signal, the playlist timeline and associated commands are related to the programming signal. For example, consider a live video broadcast of a football game. The playlist can include prescripted commands that direct a pre-show Flash movie, which may be downloaded with the master movie or fetched by the master movie, to execute along with the preshow portion of the programming signal. The playlist, for example, may include a set of time/push pairs, such as the example shown in Table 1. In this example, the playlist includes two URI pushes and a functional push. Thus, at times 1:00 and 2:05, URI pushes are provided to the application, and the application may retrieve Enhanced Content from the locations indicated by the URI(s) at the respective times. Then, at time 3:10, a functional push directs the application to execute a ShowData function with the parameters 32/23/13. In a live video broadcast of a football game, for example, the first and second URI pushes may direct the application to retrieve and play prerecorded pregame shows for each of the teams involved. The functional push may then direct the application to display the parameters 32/23/13, which may be live or prerecorded data related to the football game, e.g., scores, player statistics, and team statistics, or unrelated to the football game, e.g., stock tickers, advertisements, and breaking news updates. One benefit of having the playlist on the server is that commands can be issued or broadcast to a plurality of client devices at the same time, and can be sent in temporal relationship with the programming signal. In this way, the Flash medium becomes a synchronized mass media mechanism akin to traditional mass media such as television or radio.

TABLE 1

| Time | Push |
|---|---|
| 1:00 | http://www.hypertv.com/push1.swf |
| 2:05 | /push2.swf |
| 3:10 | {command: ShowData (33/23/13)} |

A second example consistent with the present invention for server-side control of the Flash movie on the client device includes the producer issuing a command, or commands, to the Flash movie playing on the client device. This functionality allows the producer to direct the Flash movie as it relates to the programming signal or to other Temporal Signals. In one embodiment, such as shown in FIG. 1, using a command line interface (“CLI”), the producer 114 can send a command to the server 116, which in turn will issue the command to the client device 112. The Flash movie on the client device, preferably via a persistent socket connection maintained by the receiver 132 (shown in FIG. 2) and the programming resources maintained by the JavaScript layer 134, will execute the command. For example, if the football game goes into sudden death overtime, the producer can send a command to the Flash movie 130 on the client device 112 to play a sudden death graphic, which was not part of the playlist on the server for the football game master movie, perhaps because it is unexpected or uncertain. In another example, the producer 114 (shown in FIG. 1) can create a new Flash movie and save it at a location identified by an URI, and send a command to the Flash movie 130 on the client device to connect to the URI, load the new Flash movie and present it.

Flash also includes functionality referred to as ActionScript “methods,” which can be called from the browser, to control a movie in the Flash Player from Web browser scripting languages such as JavaScript and VBScript. Such a method is generally a predefined Flash function that can be called from a host environment, which is any device capable of running a Flash movie (such as a Web browser or a stand-alone Flash player), to the Flash movie. An exemplary method is “GotoFrame,” which starts playing the Flash movie at the specified frame. A second exemplary method is “LoadMovie,” which loads an external movie from a specified URI. In one example, the producer can send new software methods to the Flash movie on the client device by commanding the download of a new Flash movie. The new Flash movie, for example, may include new software functionality with or without any additional visual or audio components. Alternatively, the playlist could be sent and loaded on the client device from the server. With the playlist resident on the client-side, the system could prefetch Flash content to use for later playback with or without a network connection.

A third example consistent with the present invention for server-side control of the Flash movie on the client device 112 includes pushing a command to jump to a movie clip index, i.e., functionality is pushed to the client device 112. The object, or other functionality, at the frame location or index, executes when the location is pushed. For example, the producer 114 may want certain text located at a specified URI to be displayed on a layer of the Flash movie. The producer will push a command to jump to the index through the JavaScript layer 134 (shown in FIG. 2), which will direct the Flash movie to the index having a getURL command, which will access the URL, get the appropriate text, and display it in a window, such as the text layer. In this example, the getURL command was prescripted and the producer 114 commanded the movie to jump to the index location for the command, wherein the functionality for accessing the URL was located.

In a fourth example consistent with the present invention for server-side control of the Flash movie on the client device, the producer 114 may push new functionality, such as a new JavaScript function expressed as a string, to the JavaScript layer 134 on the client device 112. This is especially useful for unforeseeable or uncertain events, and for non-core functionality. For example, there may be a breaking news event, and the producer 114 generates a Flash movie including text discussing the event and places it at a specified URI. The movie may include additional functionality, such as to change text as events change. The JavaScript would be able to access the new functionality in the new movie, and accordingly set the appropriate variables in the movie. The producer 114 may send the Movieclip.LoadMovie method to the client device 112, whereby the JavaScript layer 134 will communicate with the Flash movie using, for example, MovieClip.SetVariable or MovieClip.LoadMovie methods. The newly-loaded Flash movie could incorporate and execute the new functions as a new ActionScript function.

FIGS. 1, 4, 6, and 7 each illustrate a single client device, however, the present invention is equally applicable to any number of client devices. Accordingly, in one example of the present invention a single playlist running on a server, or a plurality of servers, can broadcast playlist commands to any number of client devices connected with the server, and thereby synchronously direct the Flash movies playing on the respective client devices. Moreover, the producer can issue commands to any number of subscribers, and the subscribers preferably all playing the same Flash movie on their respective client devices will contemporaneously receive the commands issued by the producer, and the Flash movie playing on their client machine will contemporaneously react to the commands. Alternatively, the subscribers may be playing different Flash movies, and are all pushed commands relating to a Temporal Signal, such as a breaking news event, which will be displayed on the same portion of their respective client devices. Flash playback systems synchronized in such a manner could become a mass medium akin to traditional mass media such as television and radio.

A second exemplary system 400 consistent with the present invention provides for server-side control of a Flash movie 412 running on a client device. Referring to FIG. 4, an embodiment of the second system 400 of the present invention is illustrated. In this embodiment, a client device 416 is connected to a network 410, such as a wireless network, an intranet, an extranet, or the Internet. Preferably, the Flash movie 412 resides at a site on the network accessible via an URI entered into a browser running on the client device 416, and the Flash movie 412 is loaded on the client device 416. Alternatively, the Flash movie 412 may be loaded from a CD-Rom, a floppy disk, or from any memory element connected to the client device. Preferably, the Flash movie 412 loaded on the client device 416 is a master movie having core functionality as discussed herein. The present invention, however, works equally well with Flash movies 412 having any degree of functionality.

A producer 404 is also connected with the network. To cause the Flash movie 412 to be reactive to Temporal Signals 402, the producer may push playlist commands to the Flash movie 412, and may push new functionality, such as a new Flash movie, to the client device 416. Preferably, the Flash movie 412 includes an ActionScript script. Accordingly, the producer 404 may push methods to a JavaScript layer 134 (shown in FIG. 2) running on the browser 136, which will expand the functionality of the JavaScript layer 134. For example, a client may be playing a Flash movie corresponding to a music video, when an unrelated Temporal Signal, such as a team winning a sporting event occurs. The producer 404 can create a Flash movie 406 relaying the Temporal Signal, such as a Flash movie including a layer with a graphic displaying the winning team and a layer with the score of the game. The producer 404 can push a command, using a server, to the Flash movie 412 on the client device 416, instructing the Flash movie 412 to fetch and play the new Flash movie 406 for the winning team on the client device 416. The enhanced JavaScript layer would allow for completely new presentation logic to be added to the Flash movie dynamically. In the beginning of the presentation, there might not be a presentation resource to show team scores. After the enhancement through the pushing of additional code (e.g., both JavaScript and Flash), however, the Flash movie would have this new capability.

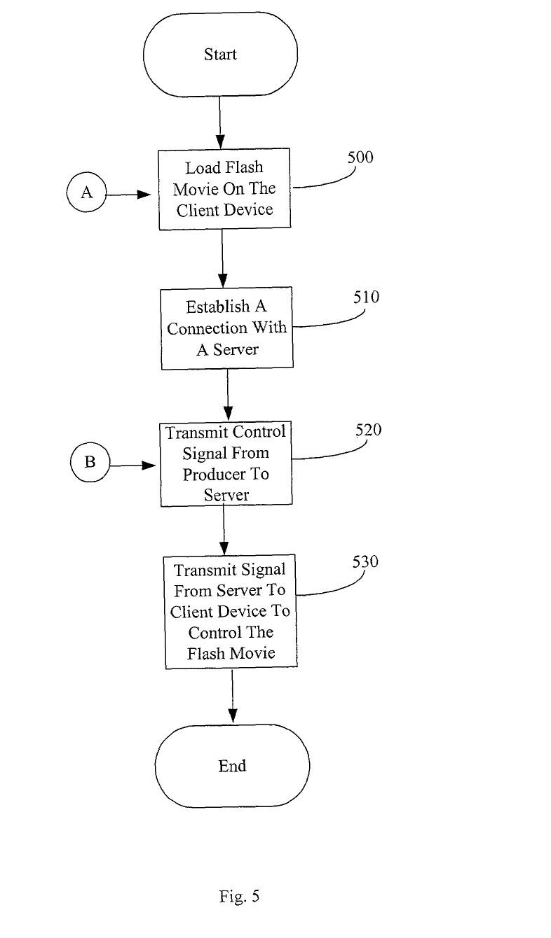

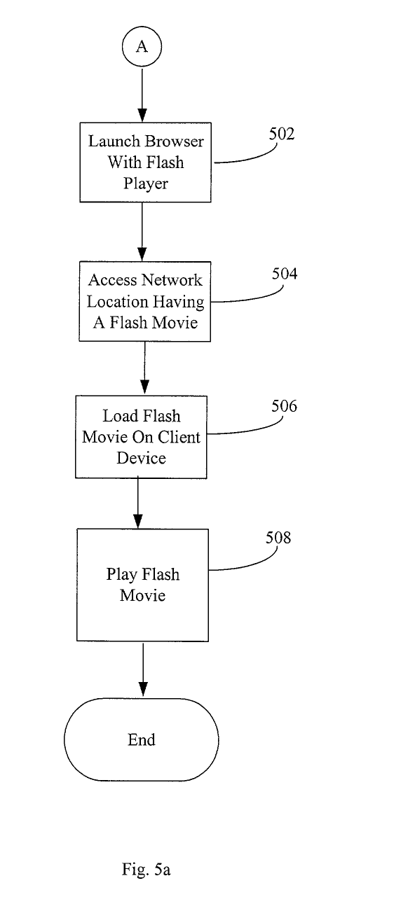

A method consistent with the present invention provides for server-side control of a Flash movie playing on a client device. Additionally, a method consistent with the present invention provides for server-side control of a Flash movie playing on a client device responsive to a Temporal Signal, or responsive to commands from a producer. Referring to FIG. 5, a method for server-side control of a Flash movie is illustrated.

In operation 500, a Flash movie is loaded on a client device. Preferably, the client device is any device with a network connection or a connection to a provider of a Flash movie, and the ability to play a Flash movie, such as a personal computer, a set-top box, a wireless device, a Web tablet, a PDA, and the like. Preferably, the client device includes a Web browser with a Flash player.

Referring to FIG. 5a, the preferred operations for loading a Flash movie on a client device are illustrated. In operation 502, the user launches a Web browser having a Flash plug-in, such as Microsoft Internet Explorer™, on the client device. In operation 504, the Web browser is connected with a network location, such as a Web site, having a Flash movie. This is preferably done by the user. Alternatively, consistent with FIG. 1, an URI for the Web site having the Flash movie may be delivered along with a Temporal Signal. Preferably, the URI may be in the first 21 lines of the vertical blanking interval of a video programming signal. Alternatively, the URI may be received directly from a Web server, or the user may enter the URI into the browser manually. For example, the user may be watching an event on TV, which indicates that an interactive Flash presentation for the TV event is available at a certain Web page, and the user connects their client device to the appropriate URI for the Web page.

In operation 506, the Flash movie is loaded on the client device. The Flash movie may include core functionality, or may simply provide a vehicle for communication with the server, as discussed below, in which case the functionality will be pushed to the Flash movie from the server responsive to commands by the producer. In operation 508, the Flash movie is played.

Referring again to FIG. 5, in operation 510, a connection between the client device and a server is established. Preferably, the client device includes a receiver (e.g., ActiveX, a Java Applet, or a Web server connection) and a bridge layer (e.g., a JavaScript or VBScript layer). In an alternative embodiment, for version Flash 5.0 and higher, the ActionScript object XMLSocket can be used, which allow a continuous connection with a server to be established. The Flash movie may be a stand-alone application commonly called a Projector. However, the user may desire to have the Flash movie reactive to Temporal Signals, such as breaking news stories, or stock prices. Alternatively, the Flash movie may provide core functionality, and the producer may push new functionality to the user based on the characteristics of the user, such as user profile information. For example, the producer may learn that the user is a 30 year old male, living in Boulder, Colo. Based on this demographic, the producer may push a Flash movie advertising high-end mountain bikes to the user.

Referring again to FIG. 5, in operation 520, the producer sends a command, directing some functionality of the Flash movie, to the server. Referring to FIG. 5b, a preferred method of producer control of the Flash movie is illustrated. In operation 522, the producer identifies a Temporal Signal, such as a breaking news story, or identifies a characteristic of the user. In operation 524, the producer sends a control signal to the server responsive to the Temporal Signal, or the characteristic of the user. For example, the producer could send a command to the server, perhaps using a CLI, that directs the master movie to display a Web page with a breaking news story.

In operation 530, the server transmits the control signal to the Flash movie using the connection between the client device and the server. Preferably, the control signal is sent using the continuous connection between the client device and the server established with the receiver and JavaScript embodiment. The control signal causes some functionality in the playlist of the Flash movie to be executed. In one embodiment, the control signal is a command to jump to an index in the timeline of the Flash movie, and causes the functionality at the index to execute. For example, the index may include a getURL command that fetches a document located at the URL, and displays the document in a browser window. In another embodiment, the control signal corresponds to new functionality, which is inserted in the Flash movie as a new movie with additional functionality, or in a layer between the Flash movie and the JavaScript Layer within the browser.

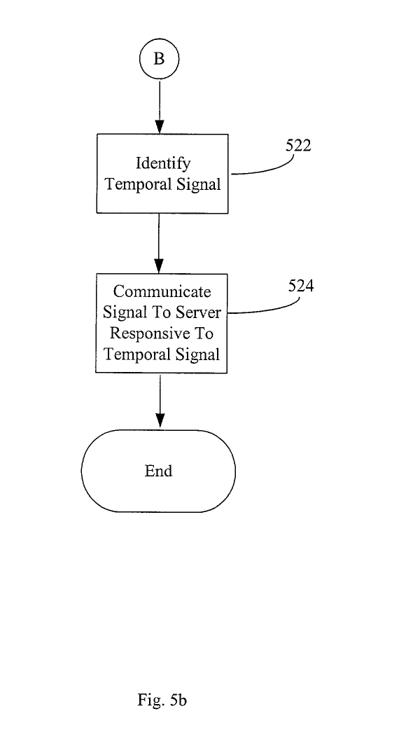

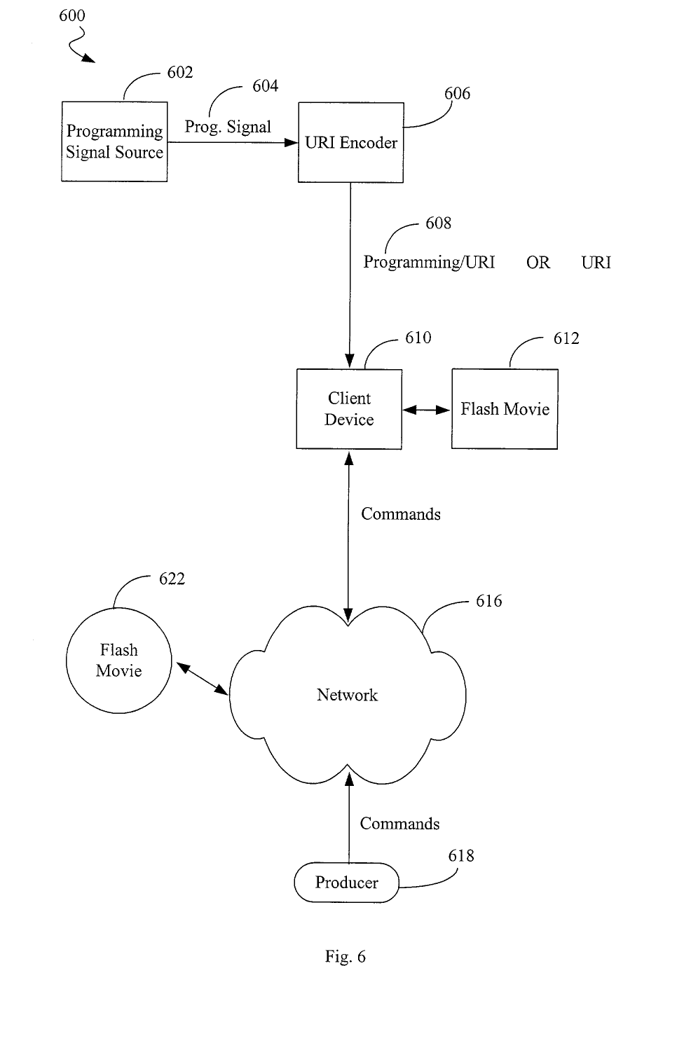

A third exemplary system 600 consistent with the present invention combines programming with the dynamic capabilities of Flash movies to provide a synchronized experience. The third system 600 also provides for server-side control of the Flash movie 622 whereby a producer 618, or server-side playlist, application, object, or script is capable of controlling the Flash movie. Referring to FIG. 6, an embodiment of the present invention is illustrated that allows a client device 610 to receive a programming signal 604 with an embedded URI that directs the client device to address locations on the network to retrieve a Flash movie 622 located at the address, collectively, the combined signal 608. Alternatively, the Flash movie 612 may be downloaded directly to the client device from a CD-ROM, a floppy, or from a memory device connected with the client device. As discussed above, the Flash movie may include an ActionScript script. In this embodiment, a producer 618 is connected with the client device via a network 616, such as the Internet, an extranet, or wireless network, and the producer 618 directs the Flash movie 612 to synchronize the Flash movie with a programming event, and/or to relate or synchronize to other Temporal Signals.

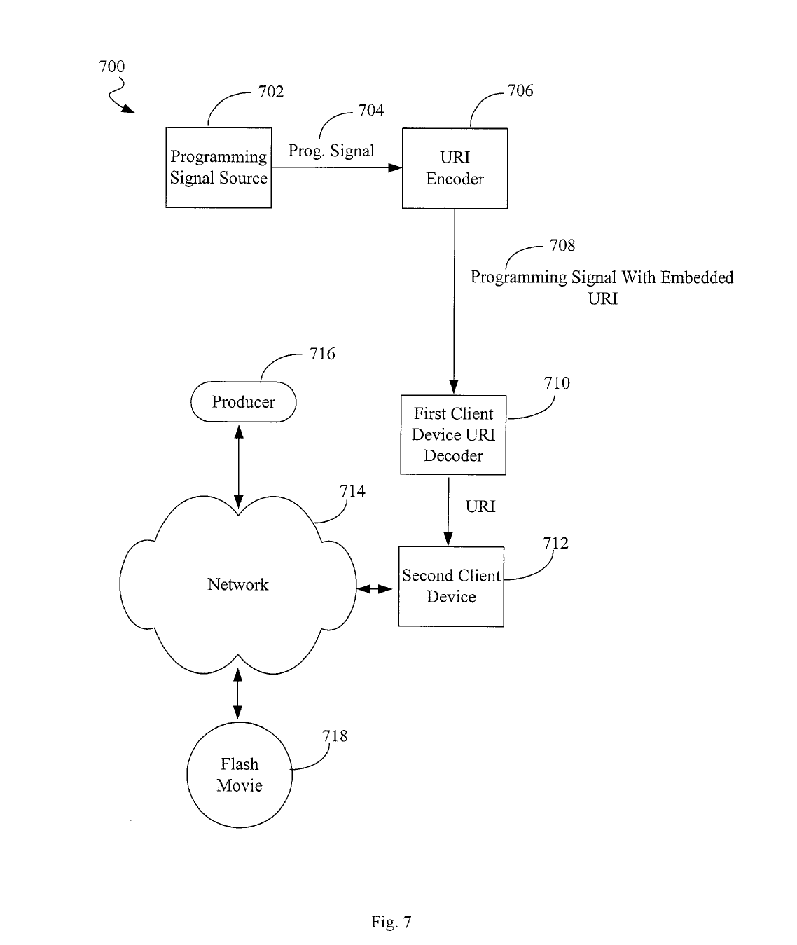

A fourth exemplary system 700 for providing server-side control of a Flash movie on a client device, consistent with the present invention, is illustrated in FIG. 7. In this embodiment, a first client device 710 receives a programming signal 704 from the programming signal source 702. The URI encoder 706 preferably embeds an URI for a Flash movie relating to the programming signal, collectively, the combined signal 708. Similarly to the first system discussed with reference to FIG. 1, an URI encoder 706 encodes the URI into the programming signal 704. The first client device 710, e.g., a digital TV, set-top box, or a personal computer, extracts the URI from the combined signal 708. The second client device 712, e.g., a PDA such as a Palm™ device, a Web tablet, or a lap-top computer, has a communication link with the first client device. The communication link may be hard wired connection such as a serial, Universal Serial Bus (“USB”), parallel, or other hard wired connection, or may be through a network such as a Bluetooth™ wireless network, the Internet, an extranet, or an intranet. After the first client device 710 extracts the URI, it is sent to the second client device 712 over the communication link. Preferably, the second client device 712 is connected to a network 714, which may also provide the communication link with the first client device 710. When the second client device 712 receives the URI, the Flash movie 718 residing at the URI is loaded on the second client device 712. The second client device 712, via the network 714, is connected with the producer 716 and/or a server. Accordingly, through the various methods discussed herein, the Flash movie 718 residing on the second client device 712 can be controlled from the producer 716 and/or a server. For example, a playlist on a server can broadcast playlist commands to all client devices subscribing to the enhanced content.

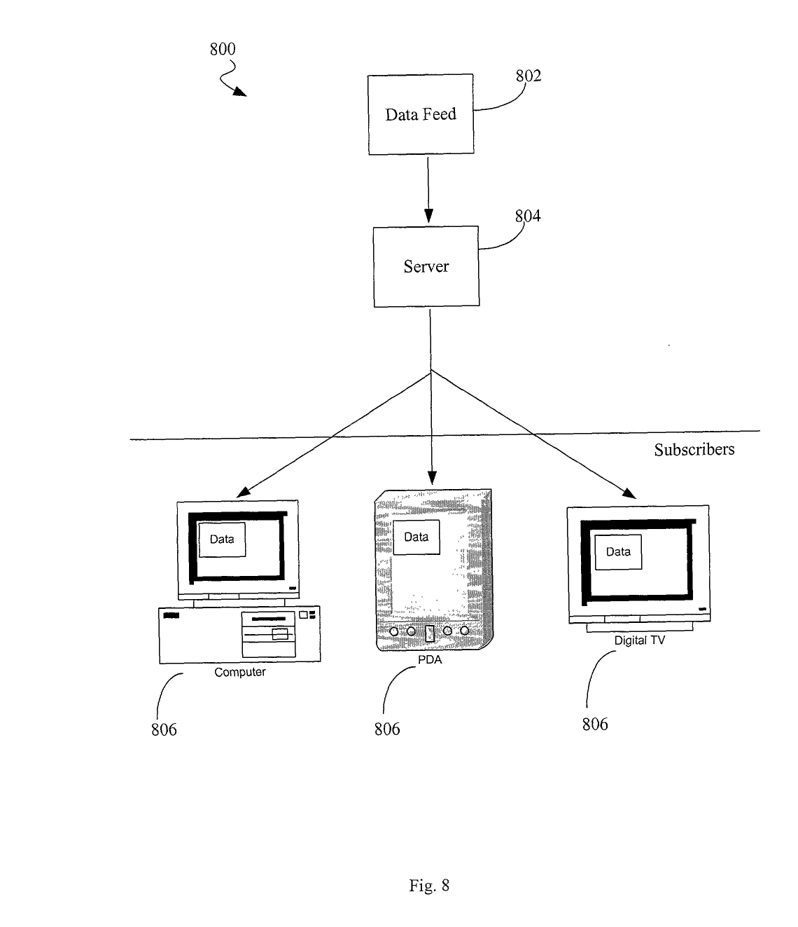

A fifth exemplary system 800 for providing server-side control of a Flash movie on a client device 806, consistent with the present invention, is illustrated in FIG. 8. In this embodiment, a Flash movie is playing on a client device 806, and a data feed 802 streams into a server 804 that parses the data feed 802 and generates commands derived from the data feed 802, which are broadcast to all subscribers to the broadcast, and the data is incorporated into the Flash movie playing on the client device 806. The data feed 802 is sent to a server 804, such as a Web server or DCN server. The server 804 encapsulates the data with the appropriate command to incorporate the data into a Flash movie playing on the client device 806. The command and associated data is then broadcast to all subscribers to the data feed 802. The client device 806 preferably includes the functionality as discussed with reference to the exemplary client device illustrated in FIG. 2. Accordingly, the receiver 132 receives the command and associated data. If the Flash movie is contained within a browser, for example, the command and associated data is relayed to the JavaScript layer 134, which communicates the command and associated data to the Flash movie 130, and the data is presented. Alternatively, the command and associated data may be relayed directly to the presentation layer if the Flash movie contains the receiver and presentation functionality, such as a Flash 5 movie utilizing XMLSocket functionality.

In one embodiment, for example, a user may subscribe to a stock-ticker data feed. Unlike HTML, the present invention allows the stock-ticker to continuously update, without a refresh. The stock-ticker data feed streams into the server, and the server incorporates the data with a command. For example, the command may instruct the Flash movie to display stock prices in the upper left hand corner of the browser window.

A system 800 may control the presentation of a data on the client device in a Flash 5 movie using XMLSocket as the receiver layer. The data, for example, may be a clock that is updated every second under the control of a server. One exemplary Java application that may be compiled and installed as a server for controlling the display of a Flash clock movie on a single client device is listed below. In this example, the clock is supplied by a Java Function call.

```
import java.awt.event.*;
import java.util.*;
import java.awt.*;
import java.io.*;
import java.net.*;
/**
  *
  * ClockServer
  * Example Server for System and Method
  for Server-Side Control of a Flash
  * Presentation
  * Will handle one example Flash client at a time.
  *
  * Usage: java -cp ./ ClockServer port
  *
  * @author Jeff Harrington
  */
public class ClockServer implements Runnable{
```

ServerSocket clockServer;
Socket clientSocket;
Thread clockThread;
PrintWriter out;
public ClockServer (int port) {

startClockServer (port);

}
private void startClockServer (int port) {

System.out.println (“Starting the clock server”);
if (clockThread == null) {

clockThread = new Thread (this, “Clock”);
clockThread.start ();

}
try {

clockServer = new ServerSocket (port);
System.out.println (“ClockServer running port: ” + port);
while (true) {

clientSocket = clockServer.accept ();
out = new

PrintWriter(clientSocket.getOutputStream (), true);

}

} catch(IOException ex) {

ex.printStackTrace ();
System.exit (0);

} catch(Exception ex) {

ex.printStackTrace ();
System.exit (0);
}

}

public void run () {

while (true) {

try {

sendTime ();
clockThread.sleep (1000);

} catch(java.lang.InterruptedException ex) {

ex.printStackTrace ();
System.exit (0);

}

}

}
public synchronized void sendTime () {

Calendar calendar = Calendar.getInstance ();
String time = “<TIME VALUE=\“”;
time += calendar.get(Calendar.HOUR_OF_DAY)

+ “:” + calendar.get (Calendar.MINUTE)
+ “:” + calendar.get (Calendar.SECOND);

time += “\” />”;
time += ‘\0’;
try {

System.out.println (“TIME = ”+time);
if (out != null) {

out.print (time);
out.flush ();

}

} catch(Exception ex) {

ex.printStackTrace ();

}

}
public static void main (String args[]) {

if (args.length == 1) {

ClockServer clockServer = new

ClockServer (Integer.parseInt (args [0]));

} else {

System.out.println (“Usage java -cp ./ ClockServer

port”);

}

}

}

Further, the following ActionScript code may be compiled into a Flash 5 movie of the client device for receiving the updated clock data from the server-side application using an XMLSocket receiver layer.

// Flash 5 ActionScript to be included into the example Flash clock display
// movie.
mySocket = new XMLSocket ();
mySocket.onConnect = handleConnect;
mySocket.onXML = handleIncoming;
mySocket.connect (“localhost”, 1024);
function handleConnect () {

trace (“CONNECTED!”);

}
function handleIncoming (message) {

var time = message.firstChild;
timeDisplay = time.attributes.value;

}
// The Flash requires a Single Line Dynamic Text area with
// variable name timeDisplay where the time will be displayed.

The server-side application listed above runs continuously and will accept one Flash movie client. The Flash movie connects to the server at startup and begins receiving an XML update expressing the time every second. The Flash movie displays the time in the text area, timeDisplay, under the control of the server-side application.

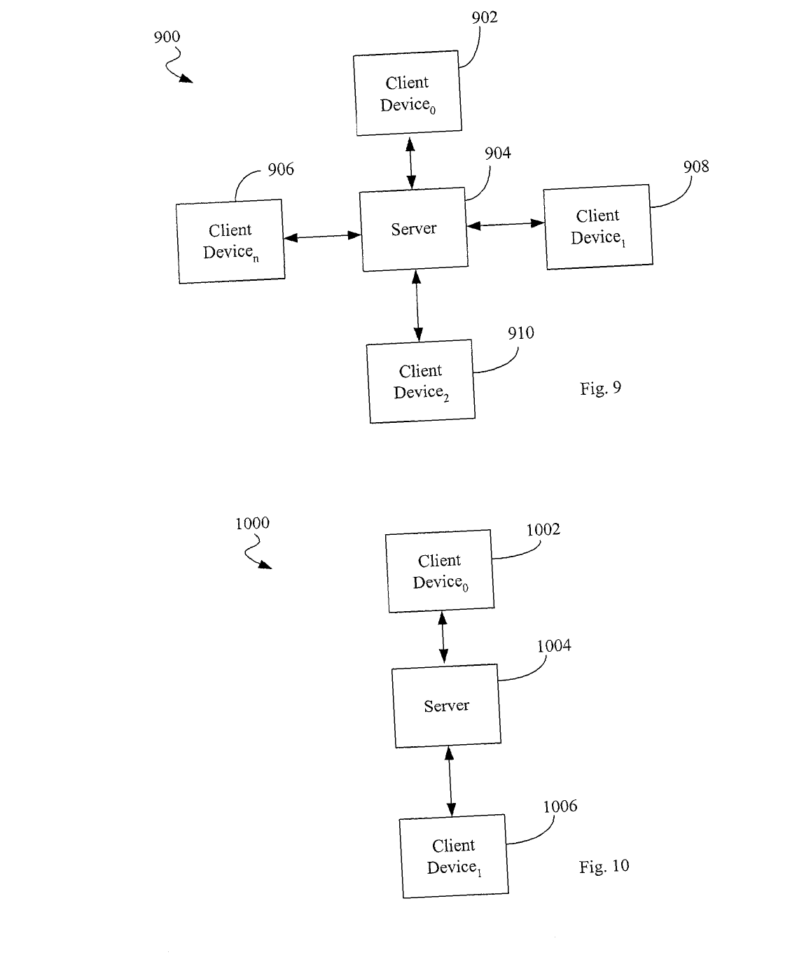

FIG. 9 illustrates a sixth exemplary system 900 consistent with the present invention, which provides for server-side control of a Flash movie playing on a client device 902, wherein the client device 902 pushes commands to the server 904, which are then broadcast to a plurality of client devices (i.e., the client in effect becomes the producer). This system is useful, for example, in chat systems and multi-player games. Consider a multiplayer Flash movie game of the word game Scrabble™; according to the present invention, whenever a player makes a move by placing a new word on the board displayed on the screen of the client device 902, perhaps by selecting and dragging letters, a command is issued corresponding to the move and is sent to the server 904. The command corresponding to the move is then sent to all of the client devices, e.g., client devices 906, 908, and 910, connected to the server 904. The command is received and preferably sent through the JavaScript layer 134 to the Flash movie 130 on the client devices 906, 908, and 910.

In a chat system consistent with the present invention, the client may push commands to the server, such as: Ignore (allows a member of a chat room to filter out unwanted chat messages from specific chat room members), Whisper (allows a member of a chat room to speak to one other particular chat room member without other chat room members seeing the chat), and ChangeChatRoom (allows a member to change chat rooms). These commands can change the client state, or the server state with regard to the users interface to the chat room, which are in addition to basic chat functionality such as sending text, and having the text broadcast to all members of the chat room.

In addition to the immediate availability of the application, a further advantage to multiplayer games, chat systems, and similar systems, is that by establishing a connection between the client device and the server, such as, but not limited to, through the receiver and the JavaScript layer on the client device or by using native Flash 5 ActionScript XMLSocket connections, whenever a command is generated in response to a user action, the command is sent to the server, and through server-side controls the command is broadcast and immediately displayed in the Flash movie on each player's client device.

FIG. 10 illustrates a seventh exemplary system 1000 consistent with the present invention, which provides for server-side control of a Flash movie playing on a client device, wherein the client pushes 1002 commands to the server 1004, which are then sent to one other client device 1006. This exemplary system is useful, for example, in two-player games and instant messaging systems. Consider a two player Flash movie game of tic-tac-toe; according to the present invention, whenever a player makes a move by putting an X or an O on the tic-tac-toe grid displayed on the screen of the client device 1002, perhaps by using a drawing tool, for example drawing an X on the screen of a Palm™ PDA client device using the Graffiti™ application, a command is issued corresponding to the X and is sent to the server 1004. The command corresponding to the move is then sent to the client device 1006 of the second player. The command is received and preferably sent through the JavaScript layer to the Flash movie on the second player's client device 1006

One particular advantage of the present invention for two-player games, instant messaging services, and similar systems, is that by establishing a connection between the first client device and the server (i.e., preferably through the receiver and the JavaScript layer on the client device) whenever a command is generated by the first client device 1002 in response to some user action, the command is immediately sent to the server 1004, and through server-side controls the command can control the Flash movie playing on the second client device 1006 of the second participant, e.g., the move is sent by the second game player or the message is received.

The client device illustrated herein preferably includes an input mechanism for generating a command, which provides for two-way interactivity. In a client device such as a personal computer, the input mechanism is generally a keyboard or a mouse, which can be used to perhaps click on a button in the Flash movie, which will generate a command that will be sent to all players in a multiplayer game, as discussed above. Alternatively, the input mechanism can include other user input mechanisms or signal generating mechanisms wherein the output from the mechanism generates a command, which can be sent to the server, and then through server-side controls sent to the client device(s). For example, an exemplary signal generating mechanism includes a sensor, which could generate a signal corresponding to some characteristic, such as the temperature, the temperature output signal from the sensor could be converted into a command, that according to the present invention would be sent through a server to the client device(s) receiving the sensor data, perhaps through a subscription. In another example, an exemplary user input mechanism includes a virtual reality suit, which could generate signals corresponding to the movements of a person wearing the suit, the movement output signals could be converted into a series of commands, that according to the present invention would be sent through a server to the client device(s). A Flash movie playing on the client device could, for example, generate a series of Flash movie animations derived from the movement commands and display the Flash movie animations on the client device. Accordingly, a person with the second client device in a geographically remote area, could, according to the present invention, load a Flash movie on the second client device, establish a connection with the server, and receive the movement commands from the server to display Flash movie animations derived from the movement commands from the first client device, i.e., users with client devices connected to the server could view the movements of the person wearing the virtual reality suit. This would be useful in any number of practical uses, including: teaching, wherein students could remotely view and interact with a teacher; gaming, wherein games could be taken to a new level by virtually physically interacting with other players; and viewing sporting events, where the movements of the field could be viewed on the client device and the viewer could interact through perhaps a chat service.

While the present invention has been described in relation to specific systems, hardware, devices, software, platforms, configurations, process routines, and a preferred embodiments, it is to be appreciated that the present invention is not limited to any specific embodiments, process, systems, devices, signal formats, data formats, and/or configurations. As such, the present invention may be considered to cover any and all subject matter, as specified in the attached claims.

1. A method for synchronizing a programming signal with a Flash movie on a client device, the method comprising:
receiving a programming signal on a client device,
receiving an URI, wherein the URI specifies a location in a network from where a Flash movie which relates to the programming signal can be obtained;
retrieving the Flash movie from the location;
loading the Flash movie on the client device, the client device including a Flash player; and
receiving a command at the client device from the server, the command directing the Flash movie on the client device.

2. The method of claim 1, wherein the programming signal includes at least one of a video signal, an audio signal, a streaming video signal, and a streaming audio signal.

3. The method of claim 1, wherein the URI is included as at least one of received with the programming signal, embedded in the programming signal, and embedded in a vertical blanking interval of the programming signal.

4. The method of claim 1, wherein the network includes at least one of a publicly accessible network, a privately accessible network, a distributed community network, a wireless network, an extranet, an Internet, and an intranet.

5. The method of claim 1, wherein the client device includes a Web browser having a Flash plug-in.

6. The method of claim 5, wherein the Web browser includes a receiver in communication with a bridge layer, the bridge layer for transmitting the command to the Flash movie.

7. The method of claim 6, wherein the receiver includes at least one of a receiver applet, an ActiveX control, a Java applet, and a persistent socket function of a Flash movie.

8. The method of claim 1, wherein the command is received through the playback of a playlist residing on a server.

9. The method of claim 1 wherein the command is generated by a producer connected with the network.

10. The method of claim 1, wherein the Flash player includes at least one of an email client capable of displaying Flash movies, a Flash projector, a Flash plug-in with persistent socket capabilities, a Flash projector with persistent socket capabilities, and a Flash projector used as a screen saver.

11. The method of claim 1, wherein the command is received via a persistent socket.

12. A program resident on a memory device accessible by a client device for synchronizing a programming signal with a Flash movie on the client device, the program comprising:
a first program component resident on a memory device for receiving a programming signal;
a second program component resident on the memory device for receiving a URI, wherein the URI specifies a location on a network from where a Flash movie that relates to the programming signal can be obtained;
a third program component resident on the memory device for retrieving the Flash movie from the location;
a fourth program component resident on the memory device for loading the Flash movie on the client device, the client device including a Flash player; and
a fifth program component resident on the memory device for receiving a command at the client device from the server, the command directing the Flash movie on the client device.

13. The program of claim 12, wherein the program is an applet.

14. The program of claim 12, wherein the client device includes a Web browser having a Flash plug-in.

15. The program of claim 14, wherein the Web browser includes a receiver in communication with a bridge layer, the bridge layer for transmitting the command to the Flash movie.

16. The program of claim 15, wherein the receiver includes at least one of a receiver applet, an ActiveX control, a Java applet, and a persistent socket function of a Flash movie.

17. The program of claim 12, wherein the command is received from the playback of a playlist on a server.

18. The program of claim 12, wherein the command is generated by a producer connected with the network.

19. The program of claim 12, wherein the Flash player includes at least one of an email client capable of displaying Flash movies, a Flash projector, a Flash plug-in with persistent socket capabilities, a Flash projector with persistent socket capabilities, and a Flash projector used as a screen saver.

20. A system for presenting a programming signal and a related Flash movie, the system comprising:
a first means for receiving the programming signal;
a second means for receiving one or more URIs, wherein the URI specifies a location on a network for the Flash movie;
a means for decoding, connected to the second means for receiving the URI to determine the location on the network for the Flash movie;
a means, connected with the decoding means, for sending message requests to the location on the network for the Flash movie and for retrieving the Flash movie residing at the network location;
a means, connected with the means for sending message requests, for playing the Flash movie;
a presentation means, connected to the first and second receiving means, for presenting the programming with the Flash movie; and
a means for receiving a control signal from a server, the control signal controlling the Flash movie.

21. The system of claim 20, wherein the programming signal contains a video signal and an audio signal.

22. An apparatus for presenting a programming signal and a related Flash movie, the system comprising:
a decoder for receiving at least one URI, decoding the at least one URI and determining a location corresponding to the URI; and
at least one presentation device for presenting a programming signal, retrieving a Flash movie from the location and presenting the Flash movie;
whereupon receiving a programming signal and at least one URI, the decoder decodes the URI to determine the location, and the at least one presentation device retrieves the Flash movie from the location, presents the Flash movie, and receives at least one command providing direction to the presentation of the Flash movie.

23. The apparatus of claim 22, wherein the at least one presentation device includes a first presentation device for presenting the programming signal and a second presentation device for presenting the Flash movie.

24. The apparatus of claim 22, wherein the presentation device presents the programming signal on a first layer and the Flash movie on a second layer.

25. The apparatus of claim 22, wherein the presentation device presents the programming signal on a first window and the Flash movie on a second window.

26. The apparatus of claim 22, wherein the URI is received as at least one of contemporaneously with the programming signal, prior to the programming signal, separately from the programming signal, embedded in the programming signal, and embedded in a vertical blanking interval of the programming signal.

27. A memory for storing data utilized to synchronize a programming signal with a Flash movie on a client device, the memory comprising:
a data structure stored in the memory, the data structure including information used by the application program and including:
a first data object utilized to receive a programming signal;
a second data object utilized to receive an URI, wherein the URI specifies a location in a network from where a Flash movie relating to the programming signal can be obtained;
a third data object utilized to retrieve the Flash movie from the location;
a fourth data object utilized to load the Flash movie on the client device, the client device including a Flash player; and
a fifth data object utilized to receive a command at the client device from the server, the command directing the Flash movie on the client device.

28. A method for controlling a Flash movie by a server, the method comprising:
identifying a Flash movie; and
sending a command from the server to a client device, wherein the command controls the presentation of the Flash movie.

29. The method of claim 28, wherein the command is sent via the playback of a playlist residing on the server.

30. The method of claim 28, wherein the command is generated by a producer connected with the network.

31. The method of claim 28, wherein the command is generated live.

32. The method of claim 28, wherein the command is received via a command line interface.

33. A method for synchronizing a programming signal with a Flash movie on a client device, the method comprising:
receiving a programming signal on a client device,
receiving an URI, wherein the URI specifies a location in a network from where a Flash movie which relates to the programming signal can be obtained;
retrieving the Flash movie from the location;
loading the Flash movie on the client device, the client device including a Flash player;
downloading a playlist from a server;
playing the playlist on the client device, wherein the playlist controls the presentation of the Flash movie on the client device.

34. A method for controlling a Flash movie by a playlist, the method comprising:
identifying a Flash movie;
downloading a playlist onto a client device from a server; and
playing the playlist on the client device, wherein the playlist controls the presentation of the Flash movie.

35. A method for providing a real-time data feed to a client device having a Flash movie, the method comprising:
receiving a real-time data feed at the server;
generating a command at a server, the command directed to a Flash movie on the client device, and the command responsive to the real-time data feed; and
sending the command to the client device;
wherein the command sent to the client device directs the Flash movie playing on the client device.

36. The method of claim 35, wherein the server is accessible via a communications link further comprising at least one of a network, an intranet, an extranet, the Internet, a distributed community network, a publicly accessible network, a privately accessible network, a wireless network, and a stand-alone configuration separate from a network.

37. The method of claim 35, wherein the command is sent via a persistent socket.

38. The method of claim 35, wherein the real-time data feed includes at least one of a stock ticker, a sports ticker, a news ticker, an advertising ticker, and a current event ticker.

39. A computer-readable data transmission medium containing a data structure configured to provide a real-time data feed to a client device having a Flash movie, the computer-readable transmission medium comprising:
a first portion receiving a real-time data feed at the server;
a second portion generating a command at the server, the command directed to a Flash movie on the client device, and the command responsive to the real-time data feed; and
a third portion sending the command to the client device;
wherein the command sent to the client device directs the Flash movie.

40. A computer readable medium providing a data structure configured to provide a real-time data feed to a client device having a Flash movie by:
receiving a real-time data feed at the server;
generating a command at a server, the command directed to a Flash movie on a client device and responsive to the real-time data feed; and
sending the command to the client device;
wherein the command sent to the client device directs the Flash movie.

41. A signal embodied in a transmission medium for controlling the presentation of a Flash movie on a client device, comprising:
a first program code segment providing an abstraction of a first receiver for receiving a programming signal;
a second program code segment providing an abstraction of a second receiver for receiving an URI, the URI specifying a location on a network of a Flash movie;
a third program code segment providing an abstraction for retrieving the Flash movie from the location;
a fourth program code segment providing an abstraction for loading the Flash movie on the client device, wherein the client device includes a Flash player;
a fifth program code segment providing an abstraction for receiving a command from a server, the command directing the presentation of the Flash movie on the client device.

42. The signal embodied in a transmission medium of claim 41, wherein the URI is included as at least one of received with the programming signal, embedded in the programming signal, and embedded in a vertical blanking interval of the programming signal.

43. The signal embodied in a transmission medium of claim 41, wherein the client device includes a Web browser having a Flash plug-in.

44. The signal embodied in a transmission medium of claim 41, wherein the command is received through the playback of a playlist residing on a server.

45. The signal embodied in a transmission medium of claim 41 wherein the command is generated by a producer connected with the network.

46. The signal embodied in a transmission medium of claim 41, wherein the Flash player includes at least one of an email client capable of displaying Flash movies, a Flash projector, a Flash plug-in with persistent socket capabilities, a Flash projector with persistent socket capabilities, and a Flash projector used as a screen saver.

47. The signal embodied in a transmission medium of claim 1, wherein the command is received via a persistent socket.
